(19) United States
(12) Patent Application Publication
(10) Pub. No.: US 2008/0021752 A1
(43) Pub. Date: Jan. 24, 2008

(54) METHOD AND SYSTEM FOR WORK SHIFT RESOLUTION USING MOBILE MESSAGING AND EMAIL

(76) Inventor: Adrian Schauer, (US)

Correspondence Address: Vortxt Interactive, Suite 202, 59 Front St. E, Toronto, ON, M5E 1B3, US

(21) Appl. No.: 11/456,162

(22) Filed: Jul. 7, 2006

(51) Int. Cl. G06F 9/46

(52) U.S. Cl. 705/8

(57) ABSTRACT

A computerized, network based, email and mobile phone messaging based work shift resolution system and method are disclosed. The system includes a server, a web interface, a mobile messaging and email messaging interface and a database that stores employee information. The web interface is available to managers allowing them to enter shift details and send an email and mobile messaging blast to qualified employees. The employee who receives an available shift notification is able to claim the shift by either composing a reply message using their mobile messaging device or by visiting a web link from their email device. The first employee to claim the shift is notified that their claim is successful, and subsequent employees who try to claim the shift will be notified either via mobile messaging or via a notification message in their web browser. Managers are able to see if a shift has been claimed and by whom, and may be notified via a mobile message when the shift is filled.

### BACKGROUND ON THE INVENTION

Employers who have multiple employees who are able to perform a function, and especially those employers who use part-time labour, often spend a large amount of effort and resources filling shifts that become available on short notice. Such employers include, without limitation, quick service restaurants, event staffing agencies, production plants, and large retailers. In this situation, a manager would typically call qualified staff one at a time, often having to leave messages and make multiple calls. The invention claimed in this patent application provides a means for the employer to save time and distribute shifts on a first-come-first-serve basis.

In recent years, the increasing penetration of mobile phones and the increased usage of mobile messaging channels such as short messaging service (SMS) have combined to make the cell phone and other mobile communication devices a viable means of communicating with employees in an efficient and time sensitive manner. In addition to this, the near-ubiquity of email service and internet access has provided a reliable, albeit less instantaneous, method of communicating with employees who may not own or choose not to use a mobile communication device.

In addition to these trends, businesses are increasingly relying on third party software services provided on an application service provider (ASP) basis to automate certain business functions. A typical example of this would be a human resources information system (HRIS) that handles other human resources functions such as payroll and scheduling. The invention described in this patent application works ideally in conjunction with such a system.

### DESCRIPTION OF THE INVENTION

The invention pertains to the method used to allow managers to fill shifts and the system used to enable this method. FIG. 1 shows the components of the system, and FIG. 2 describes the method.

The system is composed of six elements: 1) an application running on a server which presents an interface to managers allowing them to interact with the system. This application can be a stand-alone application or can be a feature integrated into an existing HRIS platform. 2) A database used to store employee information which may include among other things: employee name, skills possessed by the employee (used to match employee with the type of shift available), email address of the employee, and mobile address of the employee (which may be the employee's mobile phone number). 3) A manager interface with network connectivity. This element may be a stand alone web-based application, or may be integrated with an existing HRIS platform. 4) Connectivity to wireless carriers' messaging gateways. This element may either consist of a direct connection using a protocol such as short messaging peer-to-peer (SMPP) or may be achieved through a messaging aggregator. 5) Employee wireless messaging device. This device will typically be owned by the employee and will be addressable via a mobile messaging interface, for example a two-way text messaging (SMS) enabled cellular telephone. This device will be used to receive shift notification messages and include a reply mechanism for claiming the shift. 6) Employee email device with internet access. This device will be used to receive shift notification messages, and will include an internet enabled browser that would allow employees to click on a link in the email message to claim the available shift.

The system provides an interface for the manager to indicate the details of the available shift, and then sends notification to employees who match the criteria defined by the manager. The system then provides a mechanism for the employee to claim the shift which takes one of the following forms: 1) replying to the message with a code corresponding to the available shift, or 2) clicking a link in the message which displays a website that allows the employee to claim the available shift. The system provides notification to the employee who attempts to claim a shift informing him/her whether or not they were successful in claiming the shift or if the shift has already been filled. This notification is either provided via 1) a reply message, or 2) via the website accessed by clicking the link in the message. The status of the various shift notification messages is presented to managers in (3) the Manager Interface, and an additional feature may include a notification message to the manager when a shift is filled. Also included is a way to populate (2) the Database of Employee Information with the relevant employee details. This may be achieved by providing a web-based interface to the manager for entry of said information, or may be integrated with another system that contains said information. The system may also provide reporting on prior activity that has taken place on the system. This will typically be made available in (3) the Manager Interface or in a summary format to the employer, and may include such information as: number of shifts filled in a time period, average time to fill a shift, total messages sent, etc.

The method is described in FIG. 2, and is comprised of eight stages numbered 8 through 14. The first stage of the work shift resolution method is initiated when 7) the manager seeks to fill a shift. This can occur for a variety of reasons not relevant to this patent application. 8) The manager then logs on to the system (1) via the Manager Interface (3). The manager is authenticated via username and password, and is then able to interact with the employees defined in (2) the Employee Information Database to which he is allowed access. 9) The manager then enters the details of the shift that needs to be filled. This information may include without limitation: start time and end time of the shift, date, location, and function. These details are then matched to a subset of employees in the database who are eligible to receive the message. At this stage, there may be the option for the manager to de-select certain employees who match the criteria, but who for whatever reason the manager does not want to offer the shift to (for example, the employee is working already or is not eligible for overtime). 10) After the manager confirms the shift details and recipient list is (9) an email and mobile messaging blast is sent to qualified employees. An employee may receive both the mobile and email message or just one depending on their profile in (2) the Employee Database. If an employee wants to attempt to claim the shift, we proceed to stage 10) Employee responds to “shift available” blast. This response can take one of two forms as defined above: either the employee responds with the corresponding shift code or clicks a link that opens a website from which the employee can attempt to claim the shift. In stage 12) the application checks to see if the shift is still available (i.e.: has not been claimed by another employee or cancelled by the manager). It the shift is not available, the employee is informed at stage 12a) Employee informed that the shift is no longer available. This notification takes the form of a reply message if the employee replied to the mobile message, or if the employee clicked on the link in the email message, the employee is informed via the website (perhaps after clicking a button to confirm their intention to claim the shift) that the shift is no longer available. If the shift is available when an employee attempts to claim the shift, 12b) the Employee is informed that they have been awarded the shift. This notification takes the same form as in (12a). In stage 13) the Manager is informed that the shift has been claimed and by whom. This status is available via (3) the Manager Interface and may also be sent to the manager's mobile messaging device. 14) The shift is then closed and logged for reporting purposes.

The method may interface with an HRIS system, but the interactive messaging portion occurring by both mobile and fixed line messaging of the method is a substantive claim of this patent application.

### BRIEF DESCRIPTION OF THE DRAWINGS

FIG. 1 is a block diagram of a system that may be used to implement the present invention

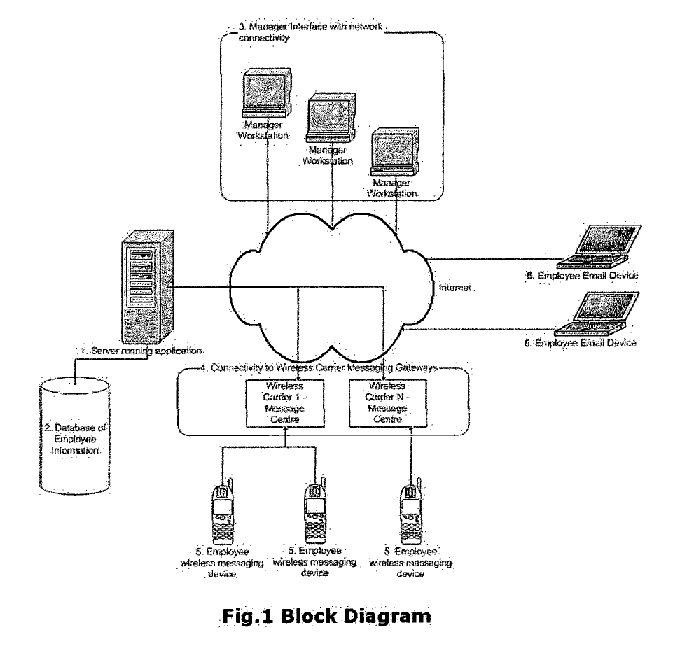

FIG. 2 is a flow diagram representing the method claimed in the present invention

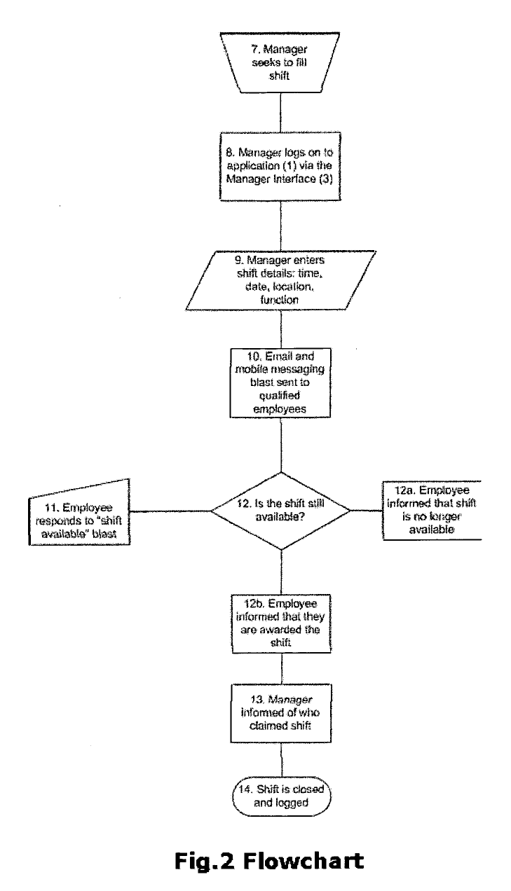

The embodiments of the invention in which an exclusive property or privilege is claimed are defined as follows:

1. A communication system comprising a) an application running on a server, b) a database containing employee information, c) a manager interface that allows a manager to interact with the application, d) an interface to a network such as the internet allowing the application to connect to wireless carrier messaging centres for the purpose of exchanging two-way mobile messages with employees' mobile messaging devices, e) an interface to a network such as the internet allowing the application to send email messages and provide a link to a destination website, which together allow a manager to use mobile messaging and email messaging blasts to employees to notify them of available shifts that match their skill sets.

2. The communication system as claimed in claim 1, wherein the interface made available to managers either via a stand-alone web application or via integration with an existing human resources information system allows managers to enter details pertaining to the shift that needs to be filled, to define and validate the recipient list, and to view the status of the shift following the ensuing messaging blast.

3. The communication system as claimed in claim 1, wherein the database containing employee information such as employee name, employee skill set, mobile messaging address, and email address, is used to determine, in conjunction with claim 2, which employees to message regarding an available shift and at what address(es) to message them.

4. The communication system as claimed in claim 3, wherein the requisite connectivity to wireless carrier network messaging centres allows message blasts to be terminated on the employees' mobile messaging devices and further allow said employees to reply to the said message to attempt to claim the shift. This connectivity allows the application to receive response messages and interpret, based on the shift code entered in the message body and the source address of the message, who is attempting the claim which shift. The application is then further able to respond to this message indicating to the employee if their attempt to claim the shift has been successful.

5. The communication system as claimed in claim 4, wherein there is an interface for email messaging and for displaying information on a website. This interface may comprise a simple mail transport protocol (SMTP) server for the delivery of email, and a web application which displays information to the employee regarding a particular shift associated with a link in the email.

6. The communication system as claimed in claim 5, wherein details of shift availability and resolution are logged for reporting purposes.

7. A communication method comprising a mechanism for a) populating a database with employee information, b) entering shift details and c) sending a “shift available” blast to appropriate employees, d) employees to respond to “shift available” message with an attempt to claim said shift, e) a mechanism for employees attempting to claim said shift to be informed whether or not their claim is successful, and f) managers to be informed when a shift is filled.

8. The method as claimed in claim 7, wherein the employee database is populated either by entering employee information via a web application, or by linking the database with an existing HRIS database.

9. The method as claimed in claim 8, wherein the manager can enter shift details such as time, location, and requisite skill set.

10. The method as claimed in claim 9, wherein the manager can send a mobile message and email blast to select employees informing them of the shift details and providing them with a mechanism to attempt to claim said shift.

11. The method as claimed in claim 10, wherein employees can respond to a “shift available” blast by either responding to the message with a corresponding shift code embedded in the message, or by clicking a link in the message to claim the shift as applicable.

12. The method as claimed in claim 11, wherein the employee attempting to claim the shift is notified whether or not the claim has been successful or whether the shift is no longer available.

13. The method as claimed in claim 12, wherein the manager who sent out the “shift available” message can verify the status of the work shift fill request and furthermore may be informed via a mobile message when the shift is filled.
